(19) United States
(12) Patent Application Publication
(10) Pub. No.: US 2016/0327996 A1
(43) Pub. Date: Nov. 10, 2016

(54) COOLING MODULE AND ELECTRONIC DEVICE

(71) Applicant: FUJITSU LIMITED, Kawasaki-shi (JP)

(72) Inventors: KENJI SASABE, Kawasaki (JP); Hideo Kubo, Kawasaki (JP); Tsuyoshi So, Kawasaki (JP); Nobumitsu Aoki, Kawasaki (JP); Masayuki Watanabe, Yokohama (JP); Fumihiro TAWA, Yokohama (JP); Yoshinori Uzuka, Kawasaki (JP)

(73) Assignee: FUJITSU LIMITED, Kawasaki-shi (JP)

(21) Appl. No.: 15/139,846

(22) Filed: Apr. 27, 2016

(30) Foreign Application Priority Data
May 8, 2015 (JP) 2015-095497

(51) Int. Cl. G06F 1/20; F28F 1/32; F28F 3/02; F28D 1/053; F28D 15/02; F28F 9/00

(52) U.S. Cl. CPC G06F 1/20; F28D 15/0275; F28D 15/0266; F28F 9/002; F28D 15/0233; F28F 3/02; F28D 1/05316; F28F 1/325; F28F 2275/20

(57) ABSTRACT

A cooling module includes: a heat exchanger mounted on an electronic part mounted on a board, and that cools the electronic part; a leaf spring including an overhang portion and an extension portion, the overhang portion overhanging outward beyond the heat exchanger from the heat exchanger, and the extension portion extending from the overhang portion in a direction intersecting an overhang direction of the overhang portion when viewed in a thickness direction of the board; and a support member located around the heat exchanger, and fixed to the board, the extension portion bent toward the board being attached to the support member.

### CROSS-REFERENCE TO RELATED APPLICATION

This application is based upon and claims the benefit of priority of the prior Japanese Patent Application No. 2015-095497, filed on May 8, 2015, the entire contents of which are incorporated herein by reference.

### FIELD

The embodiments discussed herein are related to a cooling module and an electronic device.

### BACKGROUND

There is a cooling module which includes a heat exchanger such as, for example, heat radiating fins provided on an electronic part mounted on a board so as to cool the electronic part and a resilient member attached to the board so as to bring the heat exchanger into a close contact with the electronic part.

For example, it is considered bringing a heat exchanger into close contact with an electronic part by a leaf spring which overhangs outward beyond the heat exchanger and is attached to struts provided in an outer periphery of the heat exchanger. In this case, from the viewpoint of narrowing the installation space of the leaf spring, it is desirable that the overhang length of the leaf spring overhanging outward beyond the heat exchanger is short.

However, when the deflection amount of the leaf spring remains the same, the elastic force (restoring force) generated in the leaf spring becomes larger as the overhang length of the leaf spring becomes smaller. For that reason, when the overhang length of the leaf spring is reduced, the variation amount of the elastic force generated in the leaf spring increases in the case where the deflection amount of the leaf spring is changed due to, for example, an attachment error of the leaf spring with respect to the struts. As a result, there is a possibility that it becomes difficult to control the elastic force generated in the leaf spring as the overhang length becomes decreased.

The following is a reference document.
[Document 1] Japanese Laid-Open Utility Model Publication No. 62-170644.

### SUMMARY

According to an aspect of the invention, a cooling module includes: a heat exchanger mounted on an electronic part mounted on a board, and that cools the electronic part; a leaf spring including an overhang portion and an extension portion, the overhang portion overhanging outward beyond the heat exchanger from the heat exchanger, and the extension portion extending from the overhang portion in a direction intersecting an overhang direction of the overhang portion when viewed in a thickness direction of the board; and a support member located around the heat exchanger, and fixed to the board, the extension portion bent toward the board being attached to the support member.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an exploded perspective view illustrating a heat exchanger of a cooling module according to the present embodiment;

FIG. 2 is a plan view of the cooling module illustrated in FIG. 1;

FIG. 3 is a vertical sectional view of the heat exchanger of the cooling module illustrated in FIG. 1;

FIG. 4 is a plan view illustrating a portion of FIG. 2 in an enlarged scale;

FIG. 5 is a plan view illustrating a portion of FIG. 4 in an enlarged scale;

FIG. 6 is a plan view corresponding to a portion of FIG. 5 illustrating a leaf spring according to a first comparative example in an enlarged scale;

FIG. 7 is a vertical sectional view illustrating a portion of FIG. 3 in an enlarged scale (a sectional view taken along line 7-7 in FIG. 5);

FIG. 8 is a vertical sectional view corresponding to FIG. 3 illustrating a cooling module according to a second comparative example;

FIG. 9 is a vertical sectional view corresponding to FIG. 3 illustrating a comparative example in the case where a mounting structure of the cooling module according to the second comparative example is applied to the heat exchanger according to the present embodiment;

FIG. 10 is a vertical sectional view corresponding to FIG. 3 illustrating a cooling module according to a third comparative example;

FIG. 11 is a vertical sectional view corresponding to FIG. 3 illustrating a comparative example in the case where a mounting structure of the cooling module according to the third comparative example is applied to the heat exchanger according to the present embodiment; and

FIG. 12 is a plan view corresponding to a portion of FIG. 5 illustrating a T-shaped leaf spring in an enlarged scale, which is a modification of the H-shaped leaf spring according to the present embodiment.

### DESCRIPTION OF EMBODIMENTS

Hereinafter, an embodiment of a technique of the present disclosure will be described.

(Electronic Device)

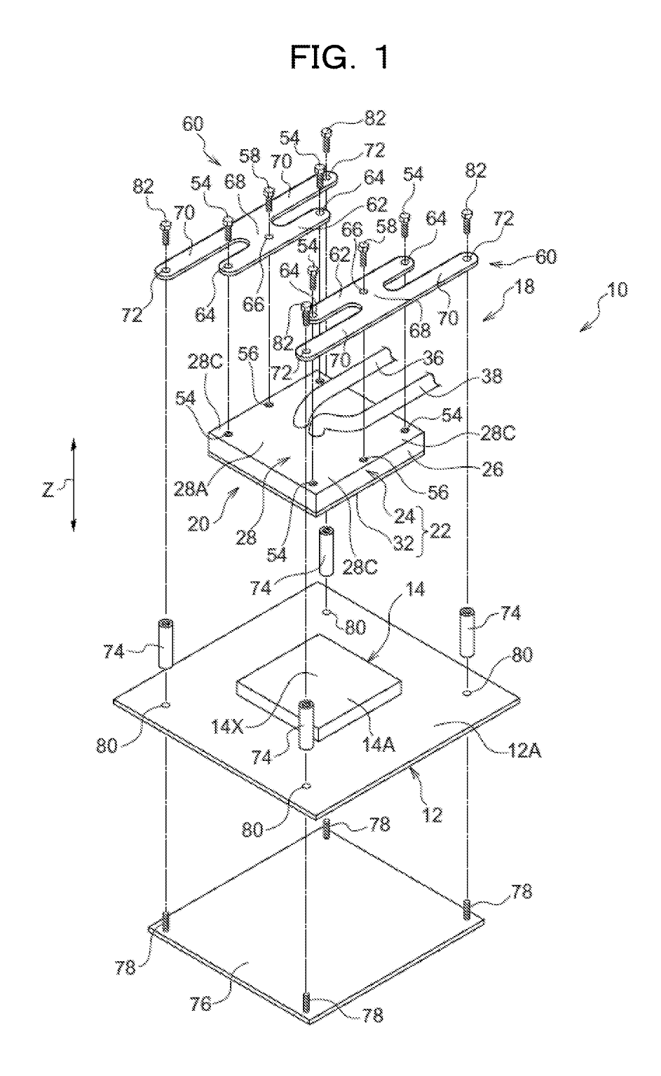

As illustrated in FIG. 1, an electronic device 10 includes a board 12 and a cooling module 18. The board 12 is, for example, a printed circuit board. The printed wiring lines (not illustrated) are formed on the front surface (upper surface) 12A of the board 12. Furthermore, an electronic part 14 is mounted on the front surface 12A of the board 12. An arrow Z properly indicated in each drawing indicates a thickness direction (plate thickness direction) of the board 12. In the present embodiment, the thickness direction of the board 12 is an up-down direction (vertical direction).

The electronic part 14 is, for example, a central processing unit (CPU). The electronic part 14 is formed in a thin rectangular parallelepiped shape and is electrically connected to the printed wiring lines formed in the board 12. The electronic part 14 is an exemplary heat generating body that generates heat by consuming electric power. The electronic part 14 is not limited to the CPU but may be any other electronic part mounted on the board 12.

(Cooling Module)

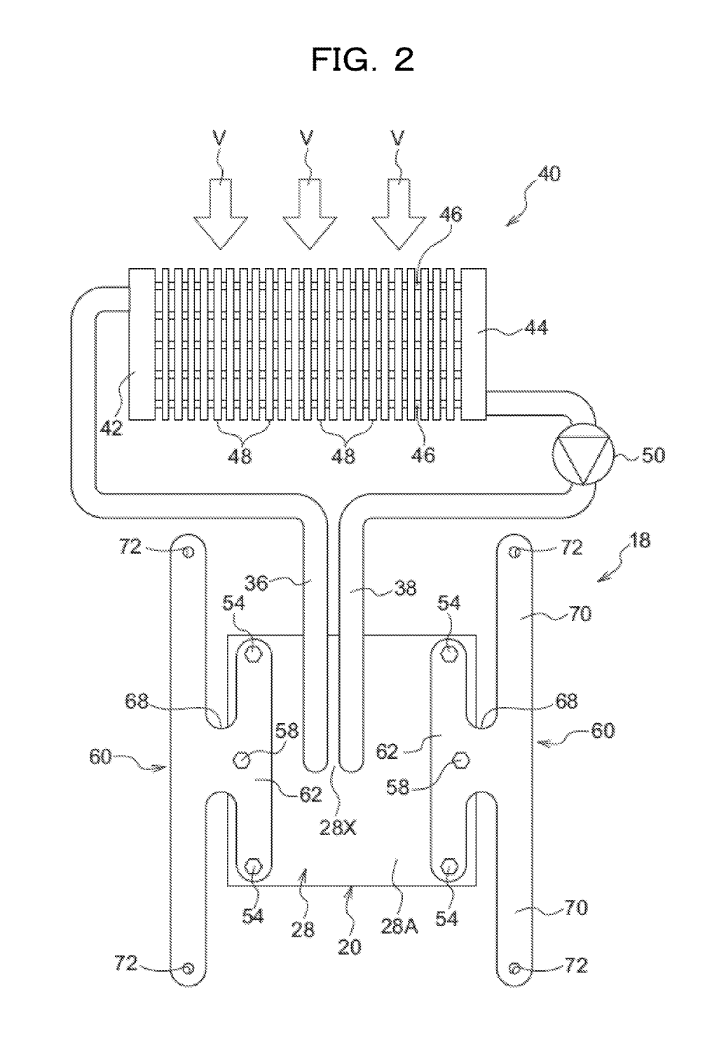

A phase-change cooling system (e.g., an evaporative cooling system) is employed in the cooling module 18 according to the present embodiment. The cooling module 18 cools the electronic part 14 by evaporating a refrigerant with the heat of the electronic part 14, and taking away the evaporating latent heat associated with the evaporation of the refrigerant from the electronic part 14. Specifically, the cooling module 18 includes a heat exchanger 20, a condenser 40 (see, e.g., FIG. 2), a mounting plate 76, a pair of H-shaped leaf springs 60, and a plurality of struts 74.

(Heat Exchanger)

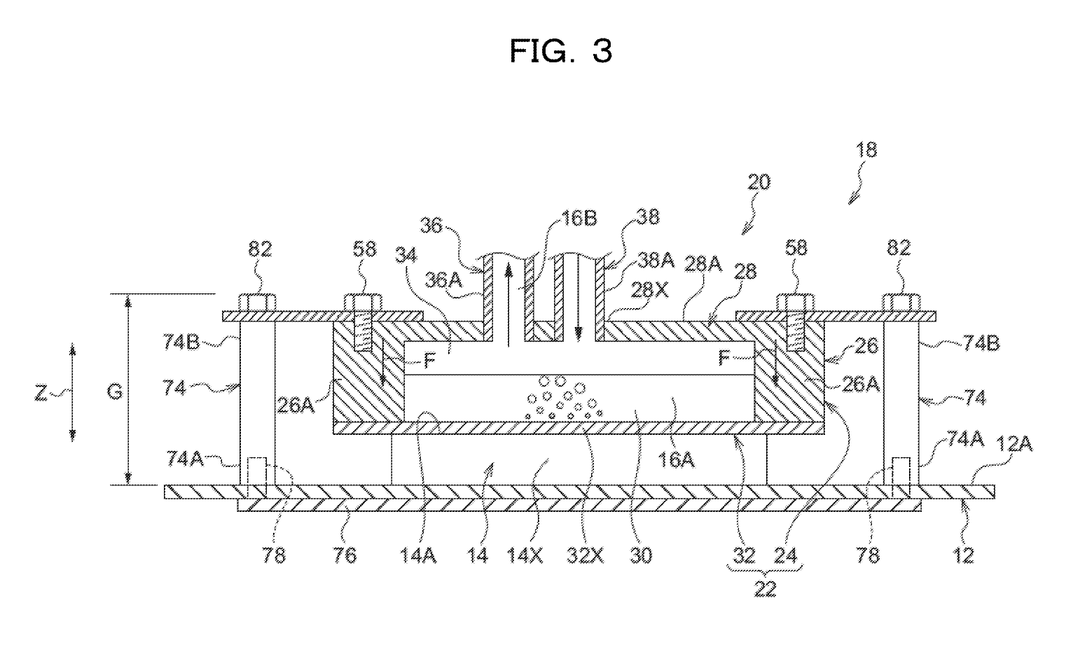

As illustrated in FIG. 3, the heat exchanger 20 includes a case 22 having an evaporation chamber 34 defined therein. When viewed in the thickness direction of the board 12 (in the direction of arrow Z), the case 22 is larger in size than the electronic part 14 and is provided on the electronic part 14 in a state where the outer peripheral portion thereof overhangs outward beyond the electronic part 14. The case 22 includes a case body 24 and a base plate 32.

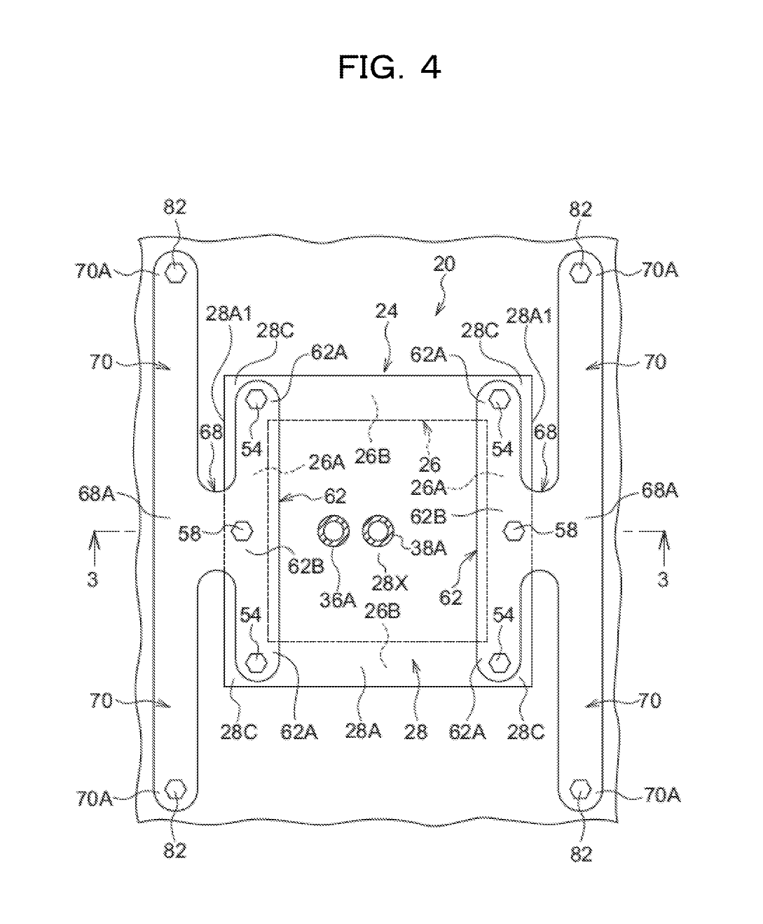

The case body 24 is formed in a box shape in which the board 12 side (the electronic part 14 side) is opened. The case body 24 includes an outer peripheral wall portion 26 and a top wall portion 28. As illustrated in FIG. 4, the outer peripheral wall portion 26 is formed in a rectangular frame shape when viewed in the thickness direction of the board 12. The outer peripheral wall portion 26 includes two sets of mutually-opposing sidewall portions 26A and 26B.

As illustrated in FIG. 3, an opening 30 is formed in the board 12 side end portion (lower end portion) of the outer peripheral wall portion 26. Meanwhile, the top wall portion 28 is integrally provided in the end portion (upper end portion) of the outer peripheral wall portion 26, which is opposite to the board 12. The top wall portion 28 closes an opening formed in the end portion of the outer peripheral wall portion 26, which is opposite to the board 12.

Furthermore, a refrigerant discharge pipe 36 and a refrigerant supply pipe 38 are respectively connected to the top wall portion 28. The surface (upper surface) of the upper wall portion 33d, which is opposite to the electronic part 14, serves as a fixing surface 28A to which the H-shaped leaf springs 60 to be described later is fixed. The fixing surface 28A is formed in a rectangular shape. The fixing surface 28A is not limited to the rectangular shape but may be, for example, a circular shape. Furthermore, the top wall portion 28 may be a member separate from the outer peripheral wall portion 26. The top wall portion 28 is an exemplary opposite wall portion that is opposite to the base plate 32.

The base plate 32 is formed in a plate shape using a metal having high heat conductivity such as, for example, aluminum or copper. The base plate 32 is air-tightly bonded to the end portion of the outer peripheral wall portion 26 at the side of the board 12. By closing the opening 30 of the case body 24 with the base plate 32, a sealed evaporation chamber 34 is formed within the case 22. A refrigerant (e.g., water) is stored in the evaporation chamber 34. In the following descriptions, a refrigerant staying in a liquid phase state will be referred to as a liquid phase refrigerant, and a refrigerant staying in a gas phase state will be referred to as a gas phase refrigerant.

The base plate 32 is superimposed on a heat radiating surface (upper surface) 14A of the electronic part 14, which is opposite to the board 12. A liquid phase refrigerant 16A stored within the evaporation chamber 34 exchanges heat with the electronic part 14 via the base plate 32. The liquid phase refrigerant 16A is evaporated by the heat exchange, and takes the evaporating latent heat from the electronic part 14, thereby cooling the electronic part 14. A gas phase refrigerant 16B generated as a result of evaporation of the liquid phase refrigerant 16A is supplied to a condenser 40 through the refrigerant discharge pipe 36. In addition, a heat transfer sheet or heat transfer grease may be interposed between the base plate 32 and the heat radiating surface 14A of the electronic part 14.

(Condenser)

As illustrated in FIG. 2, the condenser 40 includes a branch portion 42, a storage portion 44, a plurality of refrigerant flow paths 46, and a plurality of heat radiating fins 48. The branch portion 42 and the storage portion 44 are disposed in a mutually-opposing relationship. The branch portion 42 and the storage portion 44 are connected by the refrigerant flow paths 46. The condenser 40 is not limited to the aforementioned configuration.

The evaporation chamber 34 of the heat exchanger 20 is connected to the branch portion 42 via the refrigerant discharge pipe 36. Thus, the gas phase refrigerant 16B generated in the evaporation chamber 34 is supplied to the branch portion 42 through the refrigerant discharge pipe 36. Then, the gas phase refrigerant 16B supplied from the heat exchanger 20 to the branch portion 42 is supplied to the storage portion 44 through the refrigerant flow paths 46.

The refrigerant flow paths 46 are disposed in a mutually-parallel relationship. The refrigerant flow paths 46 are interconnected by the heat radiating fins 48. In the present embodiment, as indicated by arrows V, a cooling air is blown from a cooling fan (not shown) to flow along the respective heat radiating fins 48. Thus, the heat of the gas phase refrigerant supplied from the branch portion 42 to the respective refrigerant flow paths 46 is dissipated into the air (cooling air) via the heat radiating fins 48. As a result, the gas phase refrigerant is condensed into a liquid phase refrigerant. Then, the liquid phase refrigerant thus generated is supplied to the storage portion 44 by a pump 50 which will be described later.

The storage portion 44 is connected to the evaporation chamber 34 of the heat exchanger 20 via the refrigerant supply pipe 38. A pump (water pump) 50 is provided in the refrigerant supply pipe 38. Then, when the pump 50 is operated, the liquid phase refrigerant stored in the storage portion 44 is supplied to the evaporation chamber 34 of the heat exchanger 20. In response to the operation of the pump 50, the liquid phase refrigerant generated in the refrigerant flow paths 46 is supplied to the storage portion 44.

As illustrated in FIG. 3, in the electronic part 14, a heat generation amount tends to become larger in a central portion 14X. For that reason, in the present embodiment, the liquid phase refrigerant 16A is supplied from the refrigerant supply pipe 38 to a central portion 32X of the base plate 32 that is disposed on the central portion 14X of the electronic part 14.

Specifically, a vertical pipe portion 38A connected to the top wall portion 28 of the heat exchanger 20 is provided at one end side of the refrigerant supply pipe 38. The vertical pipe portion 38A is connected to a central portion 28X of the fixing surface 28A that is disposed above the central portion 14X of the electronic part 14 and the central portion 32X of the base plate 32. Furthermore, the vertical pipe portion 38A vertically extends upward from the central portion 28X of the fixing surface 28A. Thus, the liquid phase refrigerant 16A is supplied from the vertical pipe portion 38A to the central portion 32X of the base plate 32.

As in the refrigerant supply pipe 38, a vertical pipe portion 36A connected to the fixing surface 28A of the heat exchanger 20 is provided at one end side of the refrigerant discharge pipe 36. Thus, the gas phase refrigerant 16B generated in the evaporation chamber 34 is easily discharged to the condenser 40 through the vertical pipe portion 36A.

The heat exchanger 20 and the condenser 40 are air-tightly connected to each other via the refrigerant discharge pipe 36 and the refrigerant supply pipe 38. Furthermore, the internal spaces of the heat exchanger 20, the condenser 40, the refrigerant discharge pipe 36, and the refrigerant supply pipe 38 are depressurized. Thus, since the phase change of the refrigerant is promoted, for example, the liquid phase refrigerant 16A is easily evaporated in the evaporation chamber 34.

(H-Shaped Leaf Spring)

As illustrated in FIG. 4, a pair of H-shaped leaf springs 60 is disposed at the opposite sides of the heat exchanger 20, respectively, with the vertical pipe portions 36A and 38A of the refrigerant discharge pipe 36 and the refrigerant supply pipe 38 being interposed therebetween. When viewed in the plate thickness direction, the H-shaped leaf springs 60 are symmetrically disposed with respect to the central portion 28X of the fixing surface 28A of the heat exchanger 20.

Each of the H-shaped leaf springs 60 is formed of, for example, an elastic metal plate. Each of the H-shaped leaf springs 60 includes a base portion 62, an overhang portion 68, and a pair of extension portions 70. The base portion 62, the overhang portion 68, and the pair of extension portions 70 are integrally formed in an H shape when viewed in the thickness direction of the board 12. The H-shaped leaf springs 60 are exemplary leaf springs.

Each of the base portions 62 of the pair of H-shaped leaf springs 60 is fixed to the outer peripheral portion of the fixing surface 28A of the heat exchanger 20. Specifically, the base portions 62 linearly extend along the opposite side portions (edges) 28A1 of the fixing surface 28A and are disposed on the opposite sidewall portions 26A of the heat exchanger 20, respectively. Furthermore, each base portion 62 is disposed over a pair of corner portions 28C of the fixing surface 28A which exists at the opposite ends of the side portion 28A1. However, the base portion 62 may not be disposed over the pair of corner portions 28C of the fixing surface 28A.

As illustrated in FIG. 1, first attachment holes 64 (see, e.g., FIG. 1) each having a circular shape are formed in the longitudinal opposite end portions 62A of the base portion 62, respectively. Furthermore, a second attachment hole 66 having a circular shape is formed in the longitudinal center portion 62B of the base portion 62. In the meantime, a pair of first screw holes 52 is formed at the pair of corner portions 28C of the fixing surface 28A. First base portion screws 54, which are inserted into the first attachment holes 64, are tightened to the first screw holes 52, respectively.

A second screw hole 56 is formed in the central portion between each pair of corner portions 28C of the fixing surface 28A. A second base portion screw 58 inserted into the second attachment hole 66 is screwed to the second screw hole 56. The base portion 62 is fixed to the fixing surface 28A by the first base portion screws 54 and the second base portion screws 58.

The first base portion screws 54 are exemplary first fixing members. Furthermore, the second base portion screw 58 is an exemplary second fixing member. The first fixing members and the second fixing member are not limited to the screws but may be, for example, bolts or rivets.

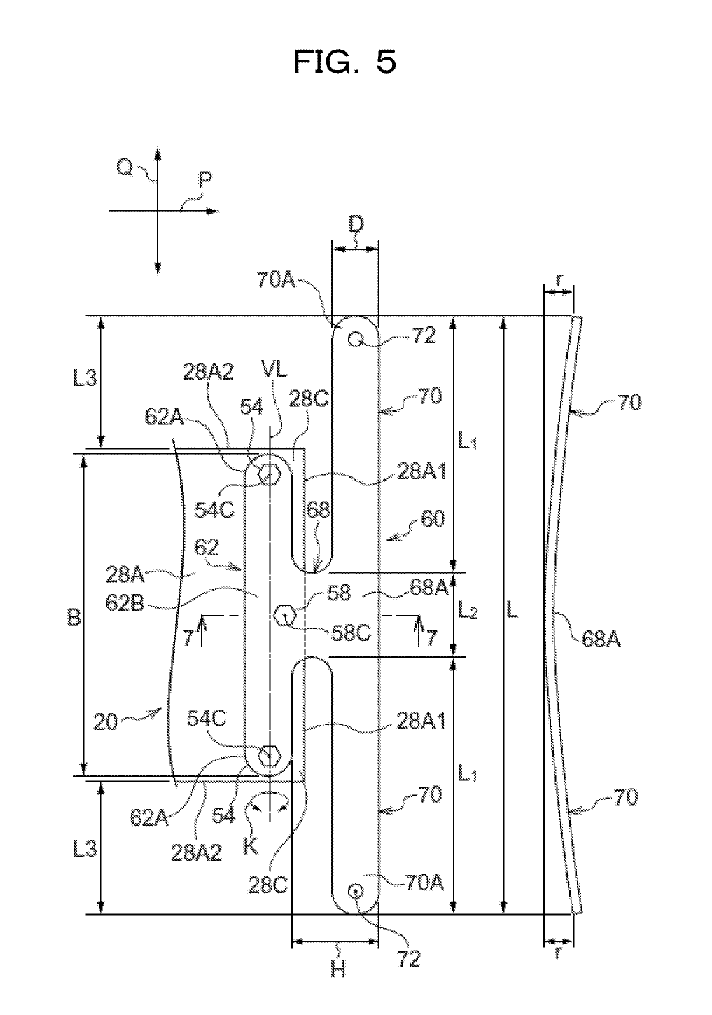

As illustrated in FIG. 5, the center 58C of the second base portion screw 58 is disposed at a position deviating to the overhang portion 68 side with respect to an imaginary straight line VL which interconnects the centers 54C of the first base portion screws 54. Thus, the rotation (indicated by an arrow K) of the base portion 62 about the straight line VL is suppressed. Furthermore, in the present embodiment, as compared with a case where the center 58C of the second base portion screw 58 is disposed at the side opposite to the overhang portion 68 with respect to the straight line VL, the floating of the overhang portion 68 about the side portion 28A1 of the fixing surface 28A is suppressed.

The overhang portion 68 is provided in the central portion 62B of the base portion 62. The overhang portion 68 extends from the central portion 62B of the base portion 62 to the outside of the heat exchanger 20, and is supported by the base portion 62 in a cantilever fashion. That is, the overhang portion 68 extends from the central portion of one side portion 28A1 of the fixing surface 28A to the outside of the heat exchanger 20. The base portion 62 and the pair of extension portions 70 are connected by the overhang portion 68. The central portion 62B of the base portion 62 is an exemplary connection portion between the base portion 62 and the overhang portion 68.

When viewed in the thickness direction of the board 12, the pair of extension portions 70 extends from a distal end portion 68A of the overhang portion 68 to the opposite sides, respectively. Furthermore, each of the pair of extension portions 70 extends in a direction which intersects the overhang direction (a direction of arrow P) of the overhang portion 68 (an intersecting direction or a direction of arrow Q). More specifically, the pair of extension portions 70 extend from the distal end portion 68A of the overhang portion 68 to the opposite sides along one side portion 28A1 of the fixing surface 28A and, at the same time, extend to the outside of the heat exchanger 20 after passing through the sides of the corner portions 28C of the fixing surface 28A. In the present embodiment, the pair of extension portions 70 and the overhang portion 68 are orthogonal to each other.

The pair of extension portions 70 are disposed in parallel with the base portion 62. The lengths L1 of the respective extension portions 70 (the effective length of a spring) are equal to each other and are larger than the overhang length H of the overhang portion 68. The pair of extension portions 70 are connected to each other through the distal end portion 68A of the overhang portion 68. The total length L of the pair of extension portions 70 including the distal end portion 68A of the overhang portion 68 is larger than the total length B of the base portion 62. However, the total length L of the pair of extension portions 70 may be equal to or smaller than the total length B of the base portion 62.

The distal end portions 70A of the pair of extension portions 70 are respectively fixed to the board 12 through the struts 74 that are set in the outer peripheries of the electronic device 10 and the heat exchanger 20. Specifically, a pair of attachment holes 72 is formed at the distal end portions 70A of the pair of extension portions 70, respectively.

As illustrated in FIG. 3, a female thread portion (not illustrated) is formed in one longitudinal end portion (lower end portion) 74A of each of the struts 74. The one end portion 74A of each of the struts 74 is fixed to the mounting plate 76 disposed on the board 12 at the side opposite to the electronic part 14. The struts 74 are exemplary support members.

Screw members 78 are provided in the corner portions of the mounting plate 76, respectively. The screw members 78 protrude through the board 12 from the corner portions 28C of the mounting plate 76, respectively. The screw members 78 are respectively screwed to one end portions 74A of the struts 74 through the through holes 80 (see, e.g., FIG. 1) that are formed in the board 12. Thus, the one end portions 74A of the struts 74 are fixed to the board 12.

Female thread portions (not shown) are formed in the other longitudinal end portions (upper end portions) 74B of the struts 74, respectively. Extension portion screws 82 are tightened to the other end portions 74B of the struts 74 through the attachment holes 72 of the distal end portions 70A of the extension portions 70, respectively. Thus, the distal end portions 70A of the extension portions 70 are fixed to the other end portions 74B of the struts 74, respectively.

The other end portions 74B of the struts 74 are disposed at the board 12 side, rather than the fixing surface 28A of the heat exchanger 20. That is, the other end portions 74B of the struts 74 are disposed at the board 12 side, rather than the overhang portion 68. Thus, when the distal end portions 70A of the extension portions 70 are fixed to the other end portions 74B of the struts 74, as illustrated in FIG. 5, the extension portions 70 are bent toward the board 12 with the distal end portion 68A of the overhang portion 68 as a fulcrum. In other words, the extension portions 70 are fixed to the other end portions 74B of the struts 74 in a state where the extension portions 70 are bent toward the board 12 with the distal end portion 68A of the overhang portion 68 as a fulcrum.

When the extension portions 70 are bent toward the board 12, elastic forces (restoring forces) F (see, e.g., FIG. 3) are generated in the extension portions 70. The elastic forces F are transferred to the fixing surface 28A of the heat exchanger 20 via the overhang portion 68 and the base portion 62. The heat exchanger 20 is pressed toward the electronic part 14 by the elastic forces F, whereby the base plate 32 of the heat exchanger 20 is brought into close contact with the heat radiating surface 14A of the electronic part 14. Thus, the heat exchange efficiency between the electronic part 14 and the liquid phase refrigerant 16A existing within the evaporation chamber 34 is enhanced.

Next, descriptions will be made on the action of the present embodiment.

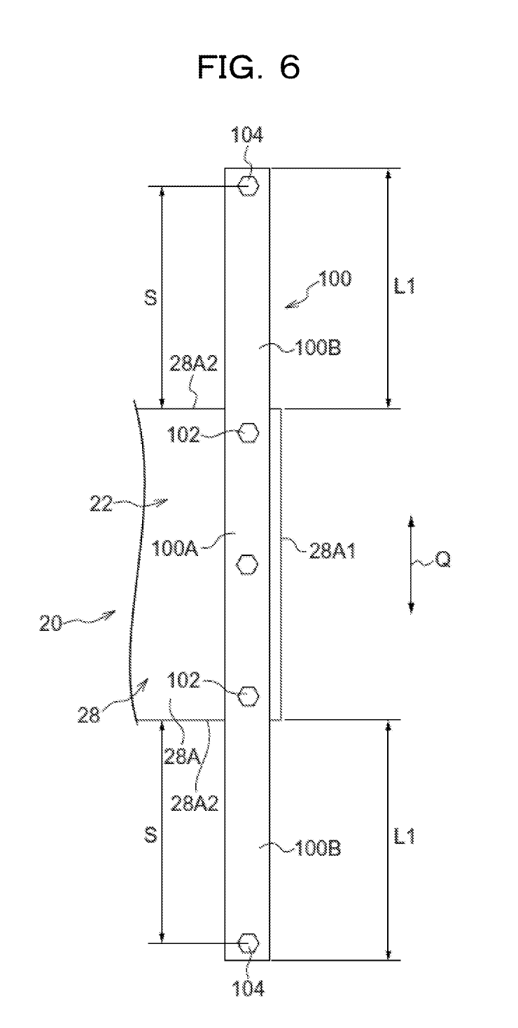

First, a leaf spring according to a first comparative example will be described. As illustrated in FIG. 6, a leaf spring 100 according to the first comparative example is formed in an elongated plate shape and disposed along one end side portion 28A1 of the fixing surface 28A. In the leaf spring 100, the middle portion in the longitudinal direction thereof becomes a base portion 100A that is fixed to the outer peripheral portion of the fixing surface 28A of the heat exchanger 20 by screws 102.

Furthermore, the longitudinal opposite portions of the leaf spring 100 become extension portions 100B that extend outward from the heat exchanger 20. The extension portions 100B are fixed to struts (not shown) by screws 104 in a state where the extension portions 100B are bent toward the board 12 with the other side portion 28A2 of the fixing surface 28A as a fulcrum. Thus, the extension portions 100B generate elastic forces that bring the heat exchanger 20 into close contact with the electronic device 10.

The length L1 of each extension portion 100B is equal to the length L1 of each extension portion 70 according to the present embodiment. Thus, in the first comparative example, installation spaces having the length L1 are respectively required at the opposite sides of the heat exchanger 20 as an installation space of the leaf spring 100 in the longitudinal direction (the direction indicated by the arrow Q).

Whereas, in each of the H-shaped leaf springs 60 according to the present embodiment, as illustrated in FIG. 5, the overhang portion 68 overhangs outward from the central portion of the side portion 28A1 of the fixing surface 28A, and the pair of extension portions 70 are provided to the distal end portion 68A of the overhang portion 68. The pair of extension portions 70 extend from the distal end portion 68A of the overhang portion 68 to the opposite sides along the side portion 28A1 of the fixing surface 28A.

Thus, in the present embodiment, the length L3 of each of the extension portions 70 extending outward from the side portion 28A2 of the heat exchanger 20 is smaller than the length L1 of each of the extension portions 100B according to the first comparative example (L3<L1). Accordingly, in the present embodiment, the installation space of each of the H-shaped leaf springs 60 in the longitudinal direction (the direction indicated by the arrow Q) is narrower than the installation space of the leaf spring 100 according to the first comparative example. That is, the present embodiment enables the longitudinal installation space of each of the H-shaped leaf springs 60 to be reduced without shortening the length L1 of each of the extension portions 70. Accordingly, the present embodiment enables an increased number of electronic parts to be mounted on the board 12.

Furthermore, in the present embodiment, the overhang portion 68 is made to extend from the central portion of one side portion 28A1 of the fixing surface 28A to the outside of the heat exchanger 20 so that the installation space of the H-shaped leaf spring 60 may be efficiently reduced.

Moreover, in the case where the overhang length H of the overhang portion 68 is short, the elastic force generated in the overhang portion 68 may be neglected. Accordingly, it becomes easier to control the elastic force F of the pair of the extension portions 70.

Furthermore, in the present embodiment, since the length L1 of each of the extension portions 70 may be increased, the extension portions 70 are capable of absorbing an error caused when attaching the extension portions 70 to the struts 74. Accordingly, since the attachment accuracy of the extension portions 70 to the struts 74 is relaxed, an attachment work of the H-shaped leaf springs 60 facing toward the board 12 may be facilitated.

Assuming that the bending amount of each of the extension portions 70 is r and a spring constant is k, the elastic force F of each of the extension portions 70 is represented by an equation F=k×r. Furthermore, assuming that the width of each of the extension portions 70 is D and the thickness of each of the extension portions 70 is t, the elastic force F of each of the extension portions 70 is proportional to the width D and the bending amount r as in the following equation (1). Furthermore, the elastic force F is proportional to the cube of the thickness t and inversely proportional to the length L1.

F∝(D×t³/L1)r (1)

For that reason, by increasing the length L1 of each of the extension portions 70, the influence of, for example, manufacturing errors of the width D and the thickness t of the extension portions 70 on the spring constant k is reduced. Furthermore, the spring constant k becomes smaller as the length L1 of each of the extension portions 70 is increased. Thus, by increasing the length L1 of each of the extension portions 70, the variation of the elastic force F of each of the extension portions 70, which is caused due to the attachment error of each of the extension portions 70, may be reduced. Accordingly, the control of the elastic force F, which is generated in each of the extension portions 70, is facilitated.

Furthermore, in the present embodiment, the length L1 of each of the extension portions 70 may be adjusted by increasing or reducing the width L2 of the overhang portion 68 without changing the attachment position of the distal end portion 70A of each of the extension portions 70 with respect to the board 12.

In addition, the attachment position of the distal end portion 70A of each of the extension portions 70 with respect to the board 12 may be changed by increasing or reducing the overhang length H of the portion 68. Accordingly, the versatility of the H-shaped leaf springs 60 is improved.

Here, as illustrated in FIG. 6, in the leaf spring 100 of the first comparative example, moment are generated at the screws 102 and 104 with the side portions 28A2 of the fixing surface 28A as fulcrums, respectively, in the state where the distal end portions of the extension portions 100B are fixed to the struts 74. In the leaf spring 100 related to the first comparative example, since the distance S from the side portions 28A2 of the fixing surface 28A to the screws 104 is increased, the moment generated at each of the screws 104 is increased. Accordingly, the strength required for the screw 104 is increased.

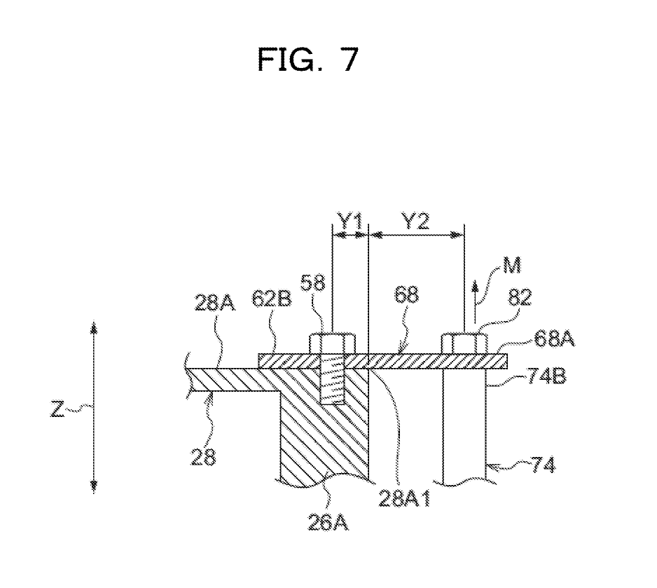

Meanwhile, in the present embodiment, as illustrated in FIG. 7, in the state where the distal end portions 70A of a pair of extension portions 70 is fixed to the 74 by the extension portion screws 82, the moments are generated at the second base portion screw 58 and each extension portion screw 82 with the side portion 28A1 of the fixing surface 28A as a fulcrum. It is assumed that the distance from the side portion 28A1 of the fixing surface 28A to the second base portion screw 58 is Y1 and the distance from the side portion 28A1 of the fixing surface 28A to the extension portion screws 82 is Y2.

In the present embodiment, the distance Y2 from the side portion 28A1 of the fixing surface 28A to the extension portion screws 82 is reduced as compared with the distance S (see, e.g., FIG. 6) of the first comparative example described above. In the present embodiment, the overhang length H (see, e.g., FIG. 5) of the overhang portion 68 is shorter than the length L1 of each extension portion 70.

Thus, in the present embodiment, compared with the leaf spring 100 according to the first comparative example, the moment M generated at each extension portion screw 82 becomes smaller. Accordingly, since the strength required for each of the second base portion screw 58 and the extension portion screws 82 becomes smaller, the durability of the cooling module 18 is enhanced.

Particularly, in the case where the heat generation amount of the electronic part 14 is large, the case 22 of the heat exchanger 20 is made of a metallic material having high heat conductivity, for example, aluminum (Al) or copper (Cu). However, aluminum or copper is easily deformable (soft). For that reason, when the case 22 of the heat exchanger 20 is made of aluminum or copper in the first comparative example, there is a possibility that the side portions 28A2 of the fixing surface 28A each serving as a fulcrum of the leaf spring 100 is deformed (crushed).

In contrast, in the present embodiment, compared with the leaf spring 100 of the first comparative example, the moment M of each H-shaped leaf spring 60 with the side portion 28A1 of the fixing surface 28A as a fulcrum becomes smaller. Thus, even if the case 22 of the heat exchanger 20 is made of aluminum or copper, the deformation (crushing) of the side portions 28A1 of the fixing surface 28A is suppressed.

Furthermore, in the present embodiment, the moment M generated at each extension portion screw 82 may be adjusted by increasing or reducing the length H of the overhang portion 68.

Next, a second comparative example will be described.

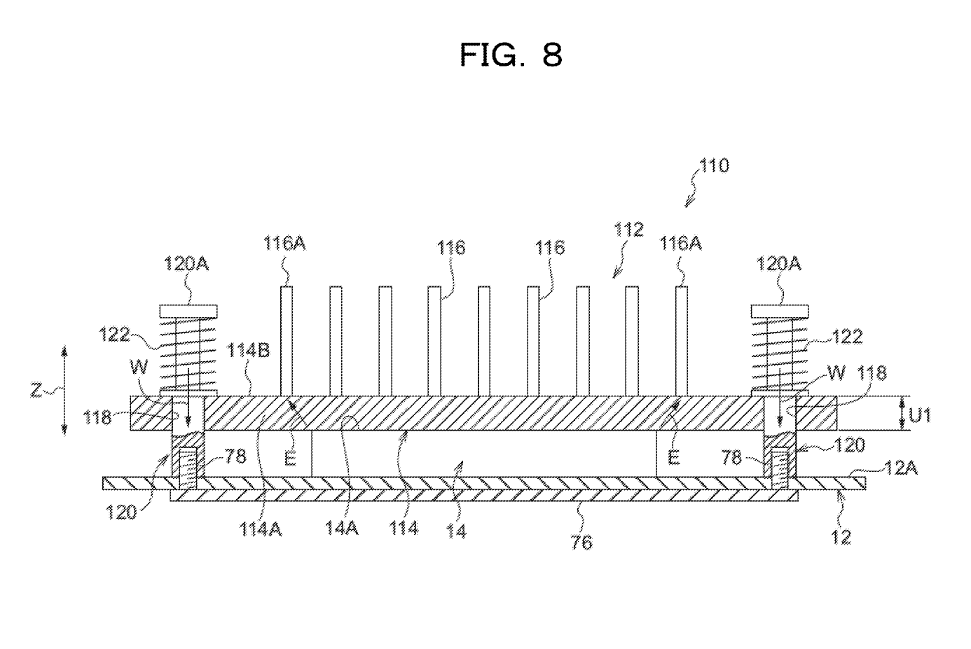

As illustrated in FIG. 8, a cooling module 110 according to a second comparative example includes a heat exchanger 112 and a plurality of elastic members 122. The heat exchanger 112 is provided on an electronic part 14. The heat exchanger 112 is an air-cooled heat exchanger. Specifically, the heat exchanger 112 includes a base plate 114 and a plurality of heat radiating fins 116. The base plate 114 is formed in a rectangular plate shape. Furthermore, the base plate 114 is superimposed on a heat radiating surface 14A of the electronic part 14 in a state where the outer peripheral portion 114A of the base plate 114 overhangs outward beyond the electronic part 14.

A plurality of attachment holes 118 is formed in the outer peripheral portion 114A of the base plate 114. A strut 120 fixed to a mounting plate 76 is inserted into each of the attachment holes 118. An elastic member 122 is provided between the distal end portion 120A of the strut 120 and the base plate 114.

The elastic members 122 are, for example, compression springs such as coil springs. The base plate 114 is brought into close contact with the heat radiating surface 14A of the electronic part 14 by the elastic forces W of the elastic members 122. Furthermore, a plurality of heat radiating fins 116 is provided on the surface 114B of the base plate 114, which is opposite to the electronic part 14.

The heat radiating fins 116 are formed in a plate shape. The heat radiating fins 116 extend from the surface 114B of the base plate 114 to the side opposite to the electronic part 14, and are arranged at predetermined intervals. Furthermore, the heat radiating fins 116 are provided not only in the central portion of the base plate 114 but also in the outer peripheral portion 114A of the base plate 114 which overhangs outward beyond the electronic part 14. Hereinafter, the heat radiating fins 116 provided in the outer peripheral portion 114A of the base plate 114 will be referred to as “outer periphery heat radiating fins 116A.”

In the cooling module 110 of the second comparative example, the thickness U1 of the base plate 114 is made to be large so that as indicated by arrows E, the heat of the electronic part 14 is easily transferred to the outer periphery heat radiating fins 116A. Thus, the bending of the base plate 114 by the elastic forces W of the elastic members 122 is suppressed.

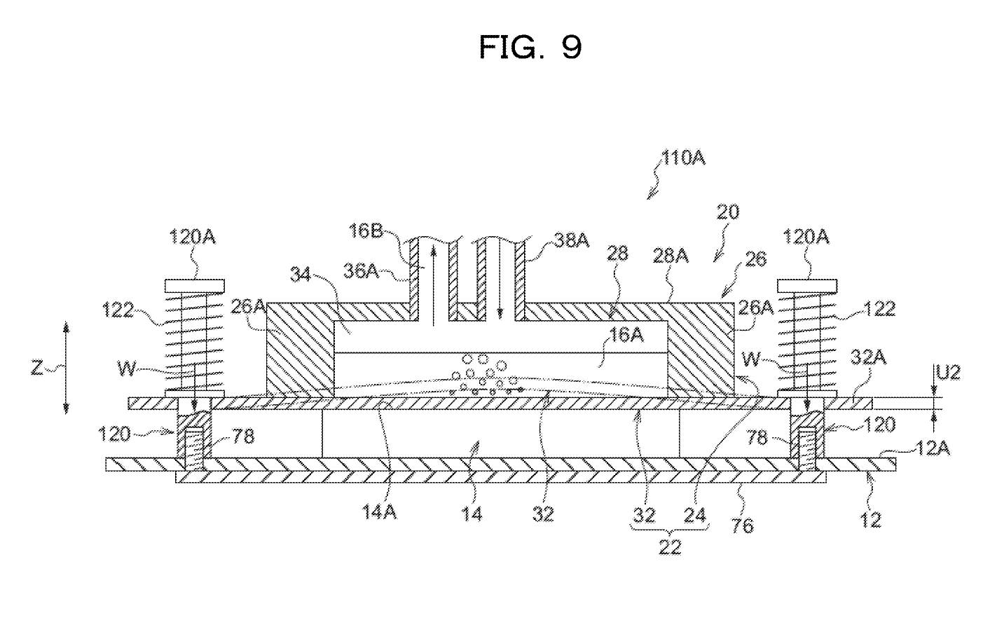

Here, a comparative example, in which a mounting structure of the cooling module 110 of the second comparative example is applied to the heat exchanger 20 according to the present embodiment, becomes as follows. That is, as in a cooling module 110A illustrated in FIG. 9, an outer peripheral portion 32A of a base plate 32 extends to the outside of the electronic part 14. The outer peripheral portion 32A is pressed against the electronic part 14 by the elastic members 122.

However, in the heat exchanger 20, the thickness U2 of the base plate 32 is smaller than the thickness U1 of the base plate 114 of the second comparative example (U2<U1) in order to increase the heat exchange efficiency between the electronic part 14 and the liquid phase refrigerant 16A within the evaporation chamber 34. For that reason, when the outer peripheral portion 32A of the base plate 32 is pressed against the board 12 by the elastic members 122, there is a possibility that the base plate 32 is bent and deformed as indicated by double-dot chain lines.

Whereas, in the present embodiment, as illustrated in FIG. 3, the fixing surface 28A of the case 22 of the heat exchanger 20 is pressed against the board 12 by the H-shaped leaf springs 60. The case 22 of the heat exchanger 20 is higher in rigidity than the base plate 32. Thus, the present embodiment enables the base plate 32 to come in close contact with the heat radiating surface 14A of the electronic part 14 while suppressing the bending and deformation of the base plate 32. Moreover, since the present embodiment enables the reduction of the thickness U2 of the base plate 32, the efficiency of heat exchange between the electronic part 14 and the liquid phase refrigerant 16A within the evaporation chamber 34 may be enhanced.

Next, a third comparative example will be described.

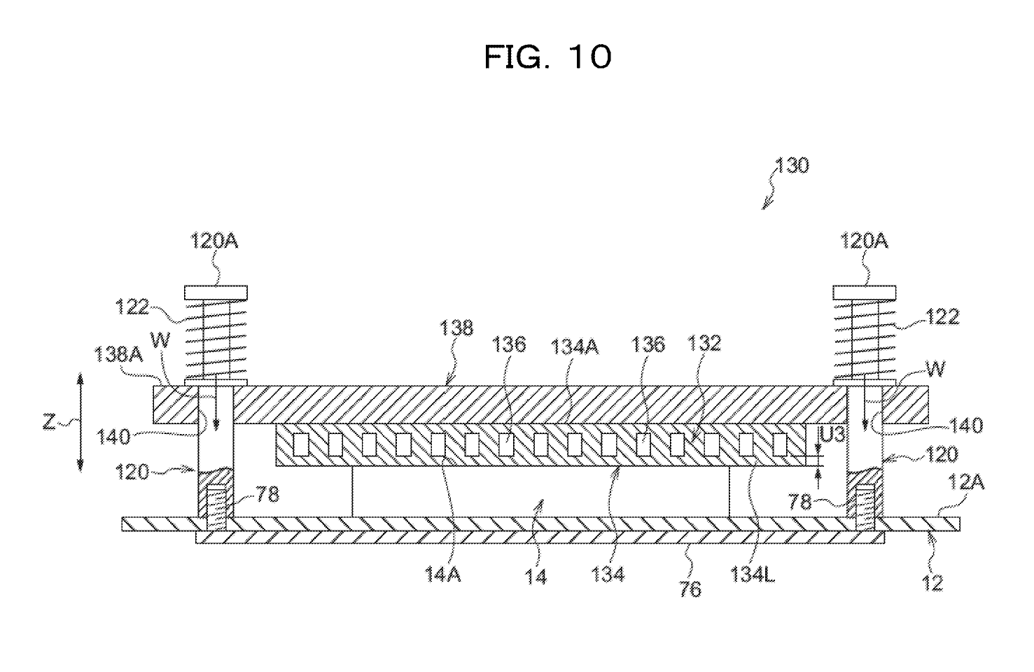

As illustrated in FIG. 10, a cooling module 130 of a third comparative example includes a heat exchanger 132, a load distribution plate 138, and a plurality of elastic members 122. The heat exchanger 132 is provided on an electronic part 14. The heat exchanger 132 is a water-cooled heat exchanger. Specifically, the heat exchanger 122 includes a casing 134 which is formed in a thin box shape. A plurality of refrigerant flow paths 136, in which a refrigerant flows, is formed within the casing 134.

In addition, a refrigerant supply pipe (not illustrated) configured to supply a cooled refrigerant to the refrigerant flow paths 136 is connected to one end side surface of the casing 134. Furthermore, a refrigerant discharge pipe is connected to the other end side surface of the casing 134 to discharge the refrigerant, which has flown in the refrigerant flow paths 136, to the outside of the casing 134. In the heat exchanger 132, the refrigerant flowing in the refrigerant flow paths 136 exchanges heat with the electronic part 14, thereby cooling the electronic part 14.

The load distribution plate 138 is provided on the surface 134A of the casing 134, which is opposite to the electronic part 14. The load distribution plate 138 is formed in, for example, a rectangular plate shape. Furthermore, the load distribution plate 138 is superimposed on the surface 134A of the casing 134 in a state where the outer peripheral portion 138A of the load distribution plate 138 overhangs outward beyond the heat exchanger 132. The load distribution plate 138 may have a circular shape without being limited to the rectangular shape.

A plurality of attachment holes 140 is formed in the outer peripheral portion 138A of the load distribution plate 138. A strut 120 fixed to the load distribution plate 138 are inserted into each of the attachment holes 140. An elastic member 122, which is similar to those of the second comparative example, is provided between the distal end portion 120A of the struts 120 and the load distribution plate 138.

In the third comparative example, the thickness U3 of a bottom wall portion 134L of the casing 134 is made to be small in order to increase the efficiency of heat exchange between the electronic part 14 and the refrigerant 16A within the refrigerant flow paths 136. In the meantime, the load distribution plate 138 is not directly related to the heat exchange of the electronic part 14 with the refrigerant flowing through refrigerant flow paths 136. For that reason, the thickness of the load distribution plate 138 may be made to be larger than the thickness U3 of the bottom wall portion 134L of the casing 134. Therefore, the bending and deformation of the load distribution plate 138 caused by the elastic members 122 may be suppressed.

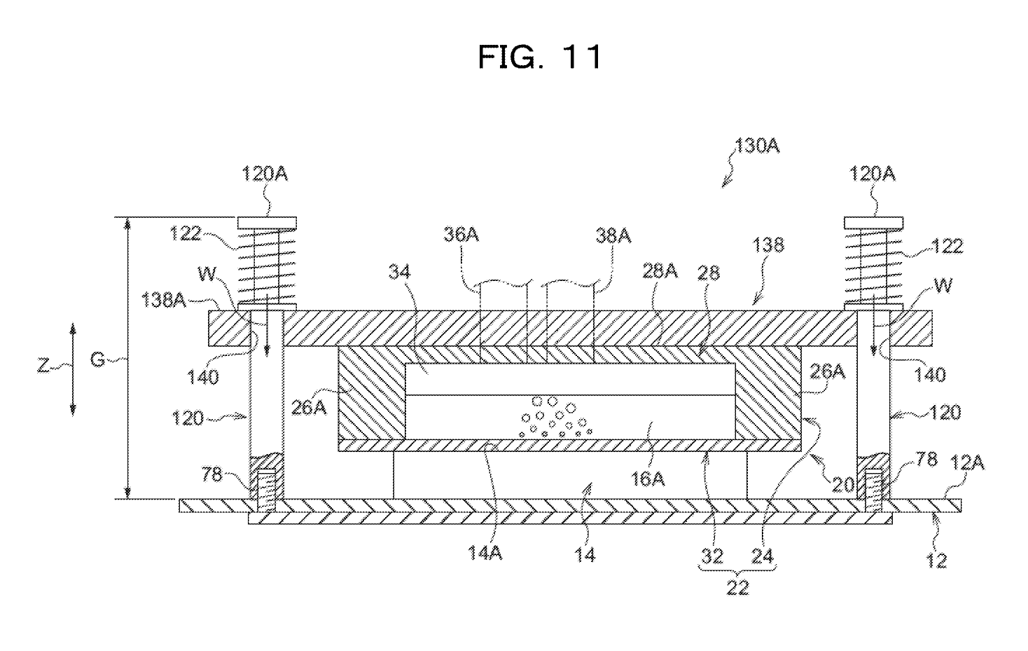

Here, a comparative example, in which a mounting structure of the cooling module 130 of the third comparative example is applied to the heat exchanger 20 according to the present embodiment, is as follows. That is, as in a cooling module 130A illustrated in FIG. 11, the load distribution plate 138 is superimposed on the fixing surface 28A of the heat exchanger 20, and the outer peripheral portion 138A of the load distribution plate 138 is pressed against the board 12 by the elastic members 122.

However, the refrigerant supply pipe 38 and the refrigerant discharge pipe 36 are connected to the fixing surface 28A of the heat exchanger 20 according to the present embodiment. Thus, in the cooling module 130A according to the comparative example, since the load distribution plate 138 interferes with the refrigerant supply pipe 38 and the refrigerant discharge pipe 36, the load distribution plate 138 is not able to be superimposed on the fixing surface 28A of the heat exchanger 20.

Furthermore, the height G of the cooling module 18 related to the present embodiment (see, e.g., FIG. 3) is set to be equal to or smaller than the height of, for example, a relatively-tall memory among a plurality of electronic parts mounted on the board 12. However, in the cooling module 130A of the comparative example, the elastic members 122 are provided on the load distribution plate 138 at the side opposite to the board 12. For that reason, there is a possibility that the height G of the cooling module 130A becomes larger than the height of the memory.

Whereas, in the present embodiment, as illustrated in FIGS. 3 and 4, the H-shaped leaf springs 60 are respectively fixed to the fixing surface 28A of the heat exchanger 20 at the opposite sides of the refrigerant supply pipe 38 and the refrigerant discharge pipe 36. Thus, the H-shaped leaf springs 60 do not interfere with the refrigerant supply pipe 38 and the refrigerant discharge pipe 36. Therefore, a pair of H-shaped leaf springs 60 may be easily attached to the fixing surface 28A of the heat exchanger 20.

Furthermore, in the present embodiment, the heat exchanger 20 is pressed against the board 12 by the elastic forces F of the extension portions 70 of the H-shaped leaf springs 60. Thus, the height G of the cooling module 18 may be reduced as compared with the cooling module 130A of the comparative example. Accordingly, in the present embodiment, the height G of the cooling module 18 may be made to be equal to or smaller than the height of the memory.

Moreover, a phase change cooling system, which is superior in cooling efficiency to the cooling modules 110 and 130 of the second comparative example and the third comparative example, is employed in the cooling module 18 of the present embodiment. Accordingly, in the cooling module 18 of the present embodiment, the electronic part 14 may be efficiently cooled.

Next, modifications of the aforementioned embodiment will be described.

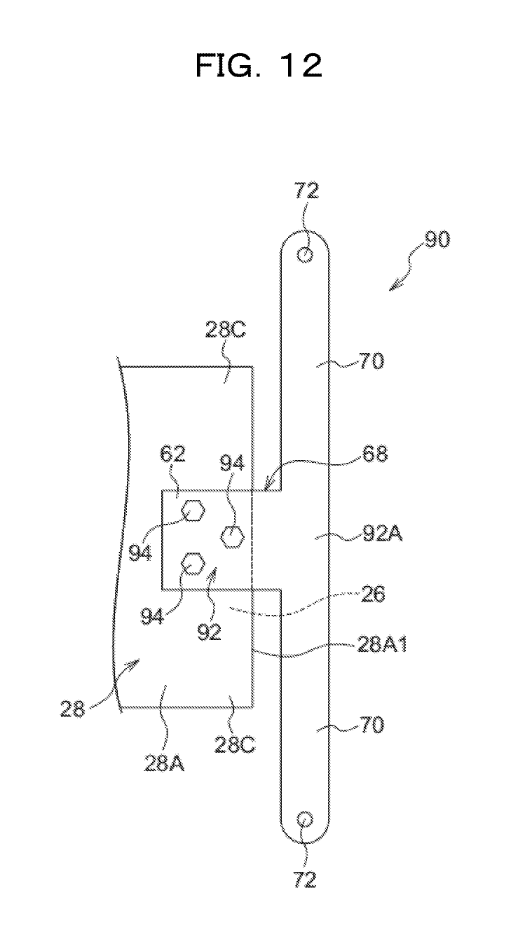

In the aforementioned embodiment, the opposite end portions 62A of the base portion 62 are respectively fixed to the opposite corner portions 28C of the fixing surface 28A. However, the aforementioned embodiment is not limited thereto. For example, as in a T-shaped leaf spring 90 illustrated in FIG. 12, a base portion 92 may be provided only in the central portion of one end side portion 28A1 of the fixing surface 28A. In this case, the T-shaped leaf spring 90 has a T shape when viewed in the thickness direction of the board 12. The base portion 92 illustrated in FIG. 12 is fixed to the outer peripheral portion of the fixing surface 28A by screws 94. Furthermore, a pair of extension portions 70 is provided in an extension-direction distal end portion 92A of the base portion 92. The T-shaped leaf spring 90 is an exemplary leaf spring.

Furthermore, in the aforementioned embodiment, the center 58C of the second base portion screw 58 is disposed at a position deviating to the overhang portion 68 side with respect to the straight line VL. However, the aforementioned embodiment is not limited thereto. For example, the center 58C of the second base portion screw 58 may be disposed at a position deviating to the side opposite to the overhang portion 68 with respect to the straight line VL, or may be disposed on the straight line VL.

Furthermore, in the aforementioned embodiment, the base portion 62 is fixed to the outer peripheral portion of the fixing surface 28A of the heat exchanger 20. However, the base portion 62 may be fixed to a portion other than the outer peripheral portion of the fixing surface 28A.

Furthermore, in the aforementioned embodiment, the overhang portion 68 extends from the central portion of one end side portion 28A1 of the fixing surface 28A to the outside of the heat exchanger 20. However, the aforementioned embodiment is not limited thereto. The overhang portion 68 may extend from a portion other than the central portion of one end side portion 28A1 of the fixing surface 28A to the outside of the heat exchanger 20.

Furthermore, in the aforementioned embodiment, a pair of extension portions 70 extends from the distal end portion 68A of the overhang portion 68. However, the pair of extension portions 70 may extend from a portion other the distal end portion 68A of the overhang portion 68.

Furthermore, in the aforementioned embodiment, a pair of extension portions 70 extends from the overhang portion 68 in the direction orthogonal to the overhang portion 68. However, the extension portions 70 may extend in the directions that intersect at the overhang portion 68. Furthermore, from the pair of extension portions, one extension portion 70 may be omitted. When a pair of extension portion 70 is provided to the overhang portion 68, the elastic force F applied to the heat exchanger 20 is stabilized as compared with a case where one extension portion 70 is provided in the overhang portion 68.

Furthermore, in the aforementioned embodiment, the distal end portions 70A of extension portions 70 are fixed to the other end portions 74B of the struts 74, respectively. However, portions other than the distal end portions 70A of the extension portions 70 may be fixed to the other end portions 74B of the struts 74, respectively.

Furthermore, in the aforementioned embodiment, the struts 74 are used as support members. However, the aforementioned embodiment is not limited thereto. Different members, which are capable of fixing the extension portions 70 to the board 12 in a state in which the extension portions 70 are bent toward the board 12, may be used as the support members.

Furthermore, in the aforementioned embodiment, two H-shaped leaf springs 60 are provided at the opposite sides of the heat exchanger 20, respectively. However, the number or arrangement of the H-shaped leaf springs 60 attached to the heat exchanger 20 may be appropriately changed.

Furthermore, in the aforementioned embodiment, a base portion 62, an overhang portion 68, and a pair of extension portions 70 are integrally formed with each other. However, at least one of the base portion 62, the overhang portion 68, and the pair of extension portions 70 may be a separate member.

Furthermore, in the aforementioned embodiment, the H-shaped leaf springs 60 are fixed to the fixing surface 28A of the heat exchanger 20. However, the aforementioned embodiment is not limited thereto. For example, extension portions may be provided to an overhang portion that overhangs from the side surface of the case 22 of the heat exchanger 20.

Furthermore, in the aforementioned embodiment, the heat exchanger 20 includes an evaporation chamber 34 that evaporates the refrigerant. However, the aforementioned embodiment is not limited thereto. For example, the heat exchanger may be a heat exchanger 112 that includes a base plate 114 and a heat radiating fins 116 as in the second comparative example illustrated in FIG. 8. In this case, the base portion 62 of each of the H-shaped leaf springs 60 is fixed to the surface 114B of the base plate 114 serving as a fixing surface. Furthermore, the heat exchanger may be, for example, a heat exchanger 132 that is provided therein with refrigerant flow paths 136 as in the third comparative example illustrated in FIG. 10. In this case, the base portion 62 of each of the H-shaped leaf springs 60 is fixed to the surface 134A of the heat exchanger 132, which is opposite to the electronic part 14 and serves as a fixing surface.

Furthermore, in the aforementioned embodiment, the electronic part 14 and the heat exchanger 20 are provided on the front surface (upper surface) 12A of the board 12. However, in the case where air-cooled heat radiating fins are used as the heat exchanger as described above, an electronic part and a heat exchanger may be provided on the lower surface of the board 12. Moreover, in the case where the air-cooled heat radiating fins are used as the heat exchanger, the thickness direction of the board 12 may be, for example, a horizontal direction.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A cooling module, comprising:
a heat exchanger mounted on an electronic part mounted on a board, and that cools the electronic part;
a leaf spring including an overhang portion and an extension portion, the overhang portion overhanging outward beyond the heat exchanger from the heat exchanger, and the extension portion extending from the overhang portion in a direction intersecting an overhang direction of the overhang portion when viewed in a thickness direction of the board; and
a support member located around the heat exchanger, and fixed to the board, the extension portion bent toward the board being attached to the support member.

2. The cooling module according to claim 1, wherein
the extension portion is extending from both sides of the overhang portion, and the support member is arranged at the opposite sides of the overhang portion, respectively, and the extension portion is attached to the support member, respectively.

3. The cooling module according to claim 1, wherein the leaf spring includes a base portion fixed to a fixing surface of the heat exchanger, which is opposite to the electronic part, and
the overhang portion overhangs outward beyond the heat exchanger from the base portion.

4. The cooling module according to claim 3, wherein the fixing surface is formed in a rectangular shape,
the overhang portion overhangs outward beyond the heat exchanger from a central portion of any side portion of the fixing surface, and
the extension portion extends from the overhang portion along the side portion.

5. The cooling module according to claim 4, wherein the base portion has longitudinal opposite end portions, each of which is fixed to the fixing surface.

6. The cooling module according to claim 5, wherein the overhang portion overhangs outward beyond the heat exchanger from a longitudinal central portion of the base portion.

7. The cooling module according to claim 5, wherein a connection portion of the base portion to be connected to the overhang portion is fixed to the fixing surface.

8. The cooling module according to claim 7, further comprising:
a pair of first fixing members configured to fix the opposite end portions of the base portion to the fixing surface; and
a second fixing member configured to fix the connection portion of the base portion to the fixing surface,
wherein, when viewed in the thickness direction of the board, a center of the second fixing member is disposed at a position deviating from a straight line interconnecting centers of the pair of first fixing members.

9. The cooling module according to claim 8, wherein the center of the second fixing member is disposed at the overhang portion side with respect to the straight line.

10. The cooling module according to claim 8, wherein the pair of first fixing members and the second fixing member are screws.

11. The cooling module according to claim 3, wherein the overhang portion, the extension portion and the base portion are integrally formed in an H shape when viewed in the thickness direction of the board.

12. The cooling module according to claim 3, wherein the heat exchanger includes an evaporation chamber configured to evaporate a liquid phase refrigerant supplied through a refrigerant supply pipe from a condenser configured to condense a gas phase refrigerant to generate the liquid phase refrigerant, by virtue of heat exchange between the liquid phase refrigerant and the electronic part, and configured to discharge the gas phase refrigerant thus generated to the condenser through a refrigerant discharge pipe,
the refrigerant supply pipe and the refrigerant discharge pipe are connected to the fixing surface, and
the base portion is disposed on the fixing surface at either side of the refrigerant supply pipe and the refrigerant discharge pipe.

13. The cooling module according to claim 12, wherein the refrigerant supply pipe is connected a top surface of a top wall portion of the evaporation chamber serving as the fixing surface.

14. The cooling module according to claim 12, wherein the base portion is disposed on an outer peripheral wall portion of the evaporation chamber and fixed to the outer peripheral wall portion.

15. The cooling module according to claim 1, wherein the overhang portion is mounted at either side of the heat exchanger.

16. The cooling module according to claim 1, wherein the heat exchanger is mounted on the electronic part via a heat conductive material.

17. The cooling module according to claim 1, wherein the extension portion is mounted in a distal end portion of the overhang portion in an overhang direction.

18. The cooling module according to claim 1, wherein a distal end portion of the extension portion in an extension direction is attached to the support member.

19. The cooling module according to claim 1, wherein the support member includes a strut having one end portion fixed to the board, the extension portion is attached to another end portion of the strut.

20. An electronic device comprising:
a board on which an electronic part is mounted; and
a cooling module including:
a heat exchanger mounted on the electronic part and configured to cool the electronic part,
an overhang portion overhanging outward beyond the heat exchanger from the heat exchanger,
a leaf spring portion extending from the overhang portion in a direction intersecting an overhang direction of the overhang portion when viewed in a thickness direction of the board, and
a support member located around the heat exchanger, and fixed to the board, the extension portion bent toward the board being attached to the support member.
